(19) United States
(12) Patent Application Publication
(10) Pub. No.: US 2014/0304496 A1
(43) Pub. Date: Oct. 9, 2014

(54) ELECTRONIC DEVICE

(71) Applicant: Kabushiki Kaisha Toshiba, Tokyo (JP)

(72) Inventor: Akira Imamura, Hamura-shi (JP)

(73) Assignee: KABUSHIKI KAISHA TOSHIBA, Tokyo (JP)

(21) Appl. No.: 14/070,242

(22) Filed: Nov. 1, 2013

(30) Foreign Application Priority Data
Apr. 3, 2013 (JP) 2013-078068

(51) Int. Cl. G06F 9/44

(52) U.S. Cl. CPC G06F 9/4401
USPC 713/2

(57) ABSTRACT

According to one embodiment, an electronic device includes a non-volatile storage, a button, a rebooting module, a memory, a control module. The rebooting module reboots the device if continuous operation time of the button exceeds a first time. Date and time information indicating date and time is stored in the memory. The date and time information becomes an initial value at a time of rebooting the device by the rebooting module. The control module stores the date and time information in the non-volatile storage if continuous operation time of the button exceeds a second time which is shorter than the first time.

### CROSS-REFERENCE TO RELATED APPLICATIONS

This application is based upon and claims the benefit of priority from Japanese Patent Application No. 2013-078068, filed Apr. 3, 2013, the entire contents of which are incorporated herein by reference.

### FIELD

Embodiments described herein relate generally to an electronic device that is capable of being rebooted by the operation of a button.

### BACKGROUND

In an electronic device, the terminal is rebooted by operating a button.

An electronic device comprises a real-time clock (RTC) to measure date and time. Date and time information is stored in the RTC.

There is provided a device in which date and time information is initialized and the date and time information disappears at the time of rebooting by operating a button.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a configuration of an electronic device according to an embodiment.

FIG. 2 is an exemplary block diagram illustrating an example of a system configuration of the electronic device according to the embodiment.

FIG. 3 is an exemplary flowchart illustrating an example of the operation of an operating system.

FIG. 4 is an exemplary timing chart illustrating an example of the operation of the electronic device.

FIG. 5 is an exemplary timing chart illustrating an example of the operation of the electronic device.

FIG. 6 is an exemplary flowchart illustrating a procedure of processing by the operating system after rebooting.

### DETAILED DESCRIPTION

Various embodiments will be described hereinafter with reference to the accompanying drawings.

In general, according to one embodiment, an electronic device comprises a non-volatile storage, a button, a rebooting module, a memory, and a control module. The rebooting module is configured to reboot the device if continuous operation time of the button exceeds a first time. Date and time information indicating date and time is stored in the memory. The date and time information becomes an initial value at a time of rebooting the device by the rebooting module. The control module is configured to store the date and time information in the non-volatile storage if continuous operation time of the button exceeds a second time which is shorter than the first time.

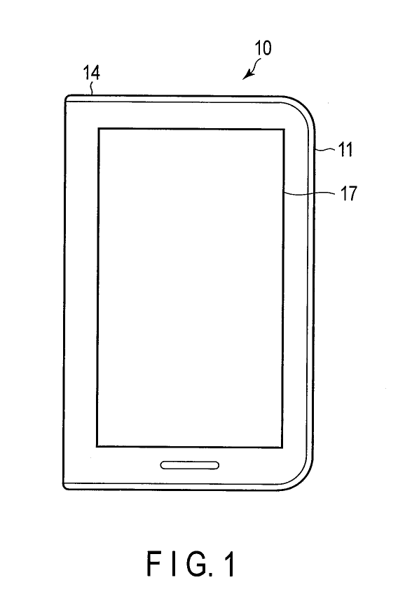

FIG. 1 is a perspective view illustrating an electronic device according to the embodiment. The electronic device is a portable electronic device that is capable of, for example, pointing by pen or finger and entering handwritten characters. The electronic device can be realized as an electronic book terminal, a tablet computer, a notebook personal computer, a smartphone, a PDA and the like. It is hereinafter assumed that the electronic device is realized as an electronic book terminal 10. The electronic book terminal 10 is a portable electronic device that is also called a book reader.

An electronic book terminal main body 11 has a thin box-type cabinet. A power button 14 to turn on/off the electronic book terminal 10 is arranged on the side of the electronic book terminal main body 11. The power button 14 is an interface to boot the terminal 10. A touchscreen display 17 is arranged on the surface of the electronic book terminal main body 11. The touchscreen display 17 comprises a flat panel display (for example, electronic paper) and an optical touchsensor. The optical touchsensor is configured to detect the position on the touchscreen display 17 that is touched by a user's finger or pen.

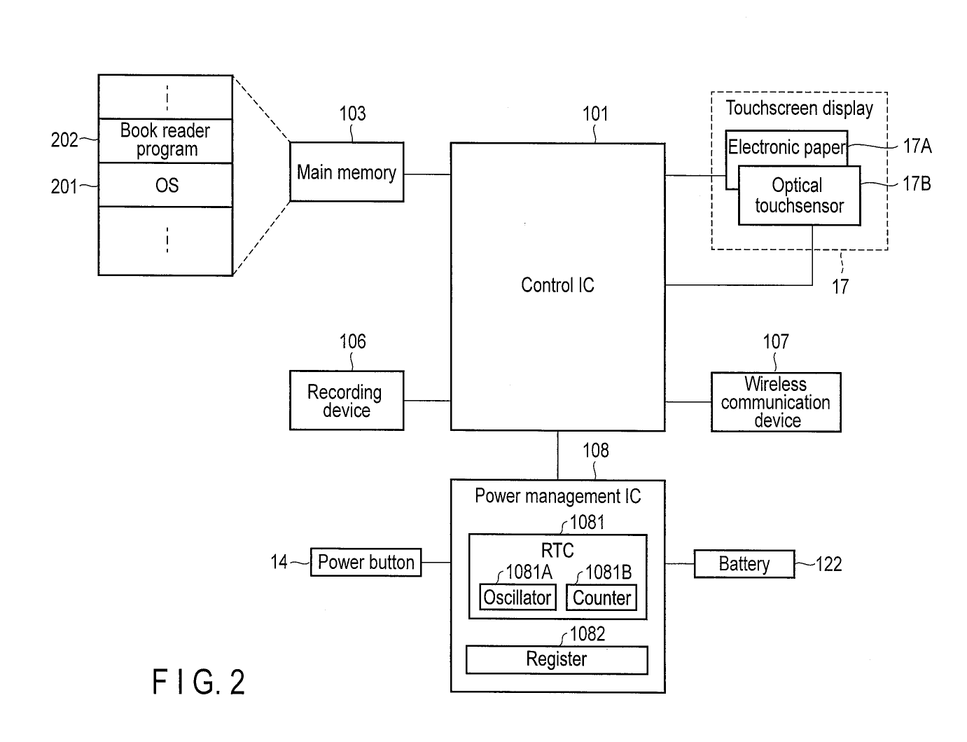

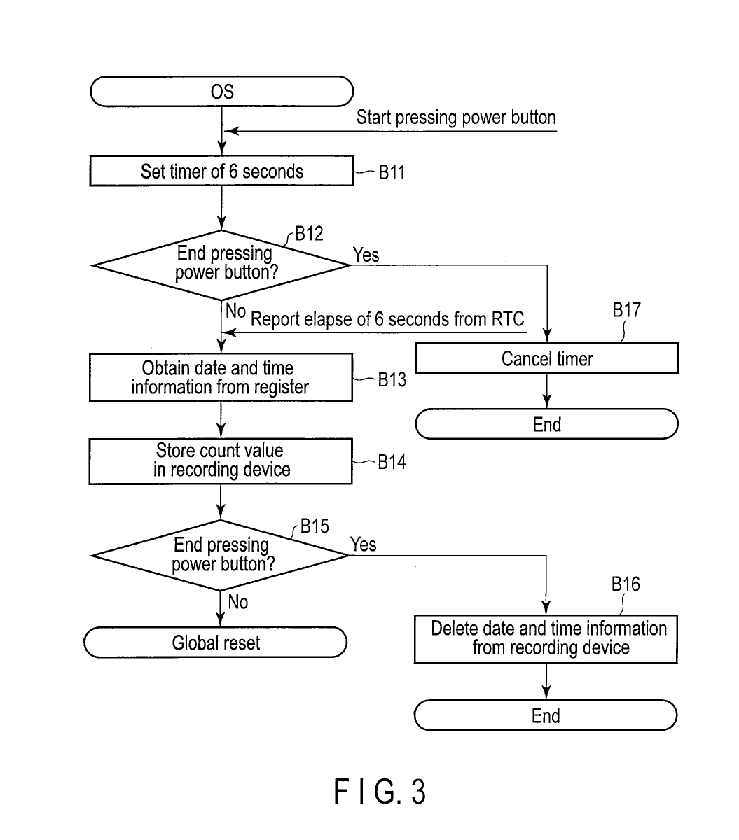

FIG. 2 is a diagram illustrating a system configuration of the electronic book terminal 10 of the embodiment.

As shown in FIG. 2, the electronic book terminal 10 comprises a control IC 101, a main memory 103, a recording device 106, a wireless communication device 107 and a power management IC 108.

The recording device 106 is a non-volatile recording portion comprising a non-volatile memory, a flash memory, a magnetoresistive memory and a hard disk drive.

The control IC 101 comprises a processor, a graphics controller, a memory controller and a USB controller.

The processor controls the operation of each type of module in the electronic book terminal 10. The processor executes each type of program that is loaded from the recording device 106 to the main memory 103. The program executed by the processor comprises an operating system (OS) 201, a book reader application program 202 and each type of application program. The book reader application program 202 is a program to download an electronic book, manage an electronic book, display an electronic book and the like.

The graphics controller is a display controller to control electronic paper 17A that is used as a display monitor of the electronic book terminal 10. A display signal generated by the graphics controller is transmitted to the electronic paper 17A. The electronic paper 17A displays a screen image based on the display signal. An optical touchsensor 17B is arranged as a position detection device on the electronic paper 17A. The optical touchsensor 17B is an optical pointing device to input characters on the screen of the electronic paper 17A. A contact position on a screen touched by finger, a motion of the contact position and the like are detected by the optical touchsensor 17B.

The wireless communication device 107 is a device configured to execute wireless communication such as wireless LAN and 3G mobile communication.

The power management IC 108 is a single-chip microcomputer for power management. The power management IC 108 has a function to turn on, turn off or sleep the electronic book terminal 10 according to a user's pressing the power button 14.

Also, the power management IC 108 generates operation power that should be supplied to each component, by using power supplied from a battery 122 in the electronic book terminal 10. Further, the power management IC 108 charges the battery 122 by using power supplied from external power.

The power management IC 108 comprises a real-time clock (RTC) 1081 and a register 1082. The RTC 1081 measures data and time. The RTC 1081 comprises an oscillator 1081A and a counter 1081B. A counter value indicating date and time is counted up per second by storing in the counter 1081B according to a clock signal generated by the oscillator 1081A. If the counter value is zero, it shows Jan. 1, 2010, 0:00:00. Also, the RTC 1081 has a timer function.

In the register 1082 as a memory, date and time information indicating the date and time measured by the RTC 1081 is stored.

Also, the power management IC 108 reboots the terminal 10 by performing a global reset, if the continuous pressing time of the power button 14 exceeds 12 seconds (first time). In a global reset, the terminal 10 is not initialized. At the time of a global reset, the power management IC 108 stops supplying operation power to each component of the terminal 10. Also, at the time of a global reset, the power management IC 108 initializes the date and time information stored in the register and requests a reset to the RTC 1081. In accordance with the reset request, the RTC 1081 deletes a count value stored in the counter 1081B and initializes the count value. The initial value of the count value becomes zero.

The operating system 201 is stored in the register 1082 and stores date and time information indicating the date and time in the recording device 106, if the continuous pressing time of the power button 14 exceeds 6 seconds (second time). The operating system 201 makes a data file having a predetermined file name, for example, in a system folder. For example, a predetermined file name is “rtc.dat.” The operating system 201 records in the data file the date and time information stored in the register 1082. If the power button 14 is not pressed before 12 seconds of the pressing time of the power button 14 elapses, the operating system 201 deletes the data file in which a count value is recorded.

After rebooting, the operating system 201 determines whether the data file having a predetermined file name is stored in the system folder. If the data file is stored in the system folder, a value recorded in the data file is read. The operating system 201 requests the power management IC 108 to write the value read to the counter 1081B. In accordance with the request, the power management IC 108 writes a value to the counter 1081B. The operating system 201 deletes the data file having a predetermined file name.

A description will be given of the operating system 201 when the power button 14 is pressed.

If the fact that the power button 14 is pressed is reported by the power management IC 108 to the operating system 201, the operating system 201 sets a timer of 6 seconds to the RTC 1081 (block B11). If the fact that the power button 14 is not pressed is reported by the power management IC 108 to the operating system 201 (block B12, Yes), the operating system 201 requests the RTC 1081 to cancel the timer (block B17). If the fact that the power button 14 is not pressed is not reported by the power management IC 108 to the operating system 201 (block B12, No) and if the fact that 6 seconds has elapsed is reported by the RTC 1081, the operating system 201 requests the RTC 1081 to transmit the date and time information stored in the register 1082. In the RTC 1081, the operating system 201 obtains date and time information by transmitting the date and time information to the operating system 201 (block B13). The operating system 201 records the date and time information of the counter 1081B in the data file of a predetermined file name (block B14). After recording the date and time information, if the fact that the power button 14 is not pressed is reported by the power management IC 108 to the operating system 201 (block B15, Yes), the operating system 201 deletes the date and time information from the recording device 106 by deleting the data file (block B16). After recording the date and time information, if the fact that the power button 14 is not pressed is not reported by the power management IC 108 to the operating system 201 (block B15, No), the power management IC 108 performs a global reset to reboot the terminal 10.

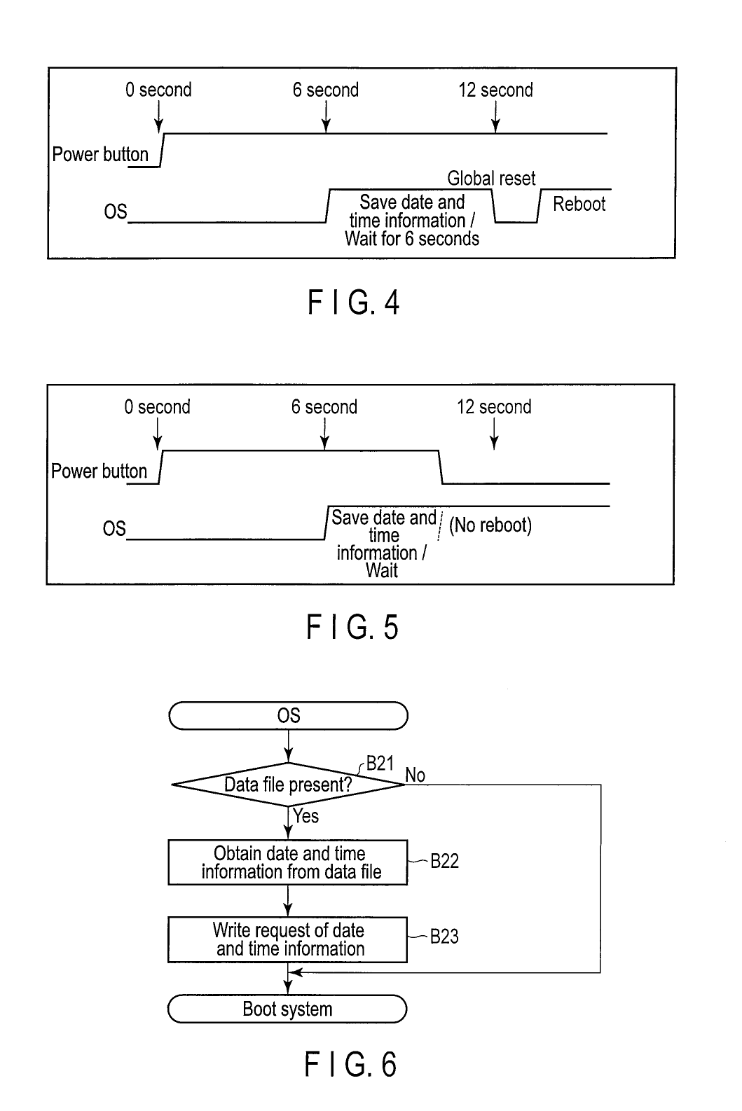

FIG. 4 is a timing chart indicating a case where the power button 14 is pressed for 12 seconds and the terminal 10 is rebooted by the power management IC 108. As shown in FIG. 4, when the continuous pressing time of the power button 14 exceeds 6 seconds, the operating system 201 stores date and time information in the recording device 106. Also, when the continuous pressing time of the power button 14 exceeds 12 seconds, a global reset is performed by the power management IC 108 to reboot.

FIG. 5 is a timing chart indicating a case where the power button 14 is pressed between 6 and less than 12 seconds and the terminal 10 is not rebooted by the power management IC 108. As shown in FIG. 5, when the continuous pressing time of the power button 14 exceeds 6 seconds, the operating system 201 stores date and time information in the recording device 106. In less than 12 seconds, the power button 14 is not pressed and a global reset is not performed by the power management IC 108.

FIG. 6 is a flowchart illustrating a procedure of processing by the operating system 201 after rebooting.

The operating system 201 determines whether the data file having a predetermined file name is stored in the system folder (block B21). If it is determined that the data file is stored (block B21, Yes), the operating system 201 reads date and time information indicating the date and time recorded in the data file (block B22). The operating system 201 requests the power management IC 108 to write the read date and time information to the register 1082 and the counter 1081B (block B23).

It may be possible to estimate the time required for rebooting in advance and to request the power management IC 108 to write to the register 1082 and the counter 1081B new date and time information in which a value corresponding to the estimated time is added to the read date and time information.

The RTC 1081 may not be built into the power management IC 108.

By storing in the recording device 106 date and time information indicating the date and time information stored in the register 1082 before rebooting by the power management IC 108, it becomes possible to prevent date and time information from disappearing from the terminal 10.

If there is content with a viewing time limit, when a value indicating a date gets back to several years ago of an initial value by a global reset, it is possible to continue to view the content with a viewing time limit by performing a global reset. As with the embodiment of the present invention, by storing date information indicating a date in the recording device 106 and by storing in the register 1082 the date information in the recording device 106 after rebooting, it becomes possible to prevent the content with a viewing time limit from continuing to be viewed.

A versatile embedded controller or the like that controls the power management IC 108 may be used instead of the power management IC 108.

A global reset may not be performed by pressing and holding the power button 14; a global reset may be performed by pressing and holding another button. For example, if a button displayed on the touchscreen display 17 is operated over a long time, a global reset may be performed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a non-volatile storage;
a button;
a rebooting module configured to reboot the device if continuous operation time of the button exceeds a first time;
a memory in which date and time information indicating date and time is stored, wherein the date and time information becomes an initial value at a time of rebooting the device by the rebooting module; and
a control module configured to store the date and time information in the non-volatile storage if continuous operation time of the button exceeds a second time which is shorter than the first time.

2. The device of claim 1, wherein the control module is configured to perform processing to store in the memory the time and date information stored in the non-volatile storage after rebooting the device.

3. The device of claim 1, wherein the control module is configured to perform processing to store in the memory new date and time information in which a predetermined value is added to the date and time information in the non-volatile storage.

4. The device of claim 1, wherein the control module is configured to delete the time and date information in the non-volatile storage if continuous operation time of the button exceeds the second time and does not exceed the first time.

5. A control method of an electronic device, wherein
the device comprises:
a rebooting module configured to reboot the device if continuous operation time of a button exceeds a first time; and
a memory in which date and time information indicating date and time is stored, the date and time information being deleted at a time of rebooting the electronic device by the rebooting module, and wherein
the control method comprises:
storing the date and time information in a non-volatile storage if continuous operation time of the button exceeds a second time which is shorter than the first time.

6. A computer-readable, non-transitory storage medium having stored thereon a computer program which is executable by a computer, wherein
the computer comprises:
a rebooting module configured to reboot the computer if continuous operation time of a button exceeds a first time, and
a memory in which date and time information indicating date and time is stored, the date and time information being deleted at a time of rebooting the computer by the rebooting module,
the computer program controls the computer to execute a function of:
storing the date and time information in a non-volatile storage if continuous operation time of the button exceeds a second time which is shorter than the first time.
